(19) United States
(12) Patent Application Publication
(10) Pub. No.: US 2024/0320559 A1
(43) Pub. Date: Sep. 26, 2024

(54) INTENT CLASSIFICATION IN LANGUAGE PROCESSING METHOD AND LANGUAGE PROCESSING SYSTEM

(71) Applicant: HTC Corporation, Taoyuan City (TW)

(72) Inventors: Yu-Shao PENG, Taoyuan City (TW); Yu-De LIN, Taoyuan City (TW); Sheng-Hung FAN, Taoyuan City (TW)

(21) Appl. No.: 18/613,127

(22) Filed: Mar. 22, 2024

Related U.S. Application Data
(60) Provisional application No. 63/491,537, filed on Mar. 22, 2023.

(51) Int. Cl. G06N 20/00

(52) U.S. Cl. CPC G06N 20/00

(57) ABSTRACT

A language processing method includes following steps. An initial dataset including initial phrases and initial intent labels about the initial phrases is obtained. A first intent classifier is trained with the initial dataset. Augmented phrases are produced corresponding to the initial phrases by sentence augmentation. First predicted intent labels about the augmented phrases and first confidence levels of the first predicted intent labels are generated by the first intent classifier. The augmented phrases are classified into augmentation subsets according to comparisons between the first predicted intent labels and the initial intent labels and according to the first confidence levels. A second intent classifier is trained according to a part of the augmentation subsets by curriculum learning. The second intent classifier is configured to distinguish an intent of an input phrase within a dialogue.

### RELATED APPLICATIONS

This application claims the priority benefit of U.S. Provisional Application Ser. No. 63/491,537, filed Mar. 22, 2023, which is herein incorporated by reference.

### BACKGROUND

### Field of Invention

The disclosure relates to a language processing method and system. More particularly, the disclosure relates to an intent classification in the language processing method and system.

### Description of Related Art

A large language model (LLM) is a type of artificial intelligence model capable of understanding and generating human-like text based on the input it receives. The large language model may use deep learning techniques, often employing architectures like transformers, to process and generate text. In order to process or interact with the text input, the large language model is required to distinguish an intent behind the text input, so as to generate a meaningful response.

### SUMMARY

An embodiment of the disclosure provides a language processing method, which includes following steps. An initial dataset including initial phrases and initial intent labels about the initial phrases is obtained. A first intent classifier is trained with the initial dataset. Augmented phrases are produced corresponding to the initial phrases by sentence augmentation. First predicted intent labels about the augmented phrases and first confidence levels of the first predicted intent labels are generated by the first intent classifier. The augmented phrases are classified into augmentation subsets according to comparisons between the first predicted intent labels and the initial intent labels and according to the first confidence levels. A second intent classifier is trained according to a part of the augmentation subsets by curriculum learning. The second intent classifier is configured to distinguish an intent of an input phrase within a dialogue.

Another embodiment of the disclosure provides a language processing system, which includes a storage unit and a processing unit. The storage unit is configured to store computer-executable instructions. The processing unit is coupled with the storage unit. The processing unit is configured to execute the computer-executable instructions to: obtain an initial dataset comprising initial phrases and initial intent labels about the initial phrases; train a first intent classifier with the initial dataset; produce augmented phrases by sentence augmentation based on the initial phrases; execute the first intent classifier to generate first predicted intent labels about the augmented phrases and first confidence levels of the first predicted intent labels; classify the augmented phrases into augmentation subsets according to comparisons between the first predicted intent labels and the initial intent labels and according to the first confidence levels; and train a second intent classifier according to a part of the augmentation subsets by curriculum learning. The second intent classifier is configured to distinguish an intent of an input phrase within a dialogue.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram illustrating a language processing system in some embodiments of the disclosure.

FIG. 2 is a flow chart diagram illustrating a language processing method according to some embodiments of the disclosure.

FIG. 3 is a schematic diagram illustrating the initial dataset and an augmented dataset according to a demonstrational example of this disclosure.

FIG. 4 is a schematic diagram illustrating the augmented dataset and a first prediction dataset according to a demonstrational example of this disclosure.

FIG. 5 is a schematic diagram illustrating the first prediction dataset and augmentation subsets after classification according to a demonstrational example of this disclosure.

FIG. 6 is a schematic diagram illustrating a step for training a second intent classifier based on some of the augmentation subsets according to a demonstrational example of this disclosure.

FIG. 7 is a schematic diagram illustrating the augmented dataset and a second prediction dataset according to a demonstrational example of this disclosure.

FIG. 8 is a schematic diagram illustrating the second prediction dataset and updated augmentation subsets according to a demonstrational example of this disclosure.

FIG. 9 is a schematic diagram illustrating a step for training a third intent classifier based on some of the updated augmentation subsets after classification according to a demonstrational example of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

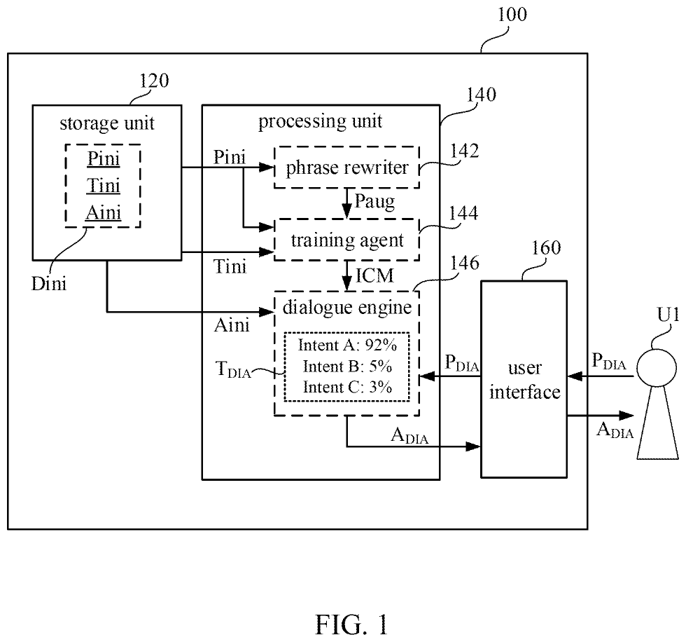

Reference is further made to FIG. 1, which is a block diagram illustrating a language processing system 100 in some embodiments of the disclosure. As shown in FIG. 1, the language processing system 100 includes a storage unit 120, a processing unit 140 and a user interface 160. In some embodiments, the language processing system 100 can be a computer, a smartphone, a tablet, an image processing server, a data server, a tensor computing server or any equivalent processing device.

As shown in FIG. 1, the storage unit 120 records an initial dataset Dini, which include some initial phrases Pini, initial intent labels Tini about the initial phrases, and initial answers Aini corresponding to the initial phrases Pini.

In some embodiments, the initial dataset Dini can be collected from a question-and-answer (Q&A) data set accumulated in a large language model or a language processing application.

As shown in FIG. 1, the processing unit 140 is configured to operate a phrase rewriter 142, a training agent 144 and a dialogue engine 146. The dialogue engine 146 may operate a large language model (LLM) to process a dialogue between the language processing system 100 and a user U1. In some embodiments, the initial phrases Pini and the initial intent labels Tini in the initial dataset Dini can be utilized by the training agent 144 to train an intent classifier ICM.

In practical applications, the intent classifier ICM is a key component of the dialogue engine 146. The intent classifier ICM helps the dialogue engine 146 to understand the purpose or goal behind a given phrase. The intent classifier ICM is configured to categorize the given phrase into different intent categories, such as asking a question, making a statement, expressing a command, etc. The intent classifier ICM helps the dialogue engine 146 better interpret and respond to user inputs more accurately.

For example, when the user U1 inputs an input phrase P_{DIA} within a dialogue through the user interface 160 (e.g., a touch panel, a microphone, a keyboard, a mouse, a head-mounted display or a data transmission interface), the input phrase P_{DIA} is transmitted to the dialogue engine 146. The dialogue engine 146 utilizes the intent classifier ICM to distinguish an input intent T_{DIA} of the input phrase P_{DIA} within the dialogue, such that the dialogue engine 146 is able to generate a suitable answer A_{DIA} according to the input intent T_{DIA}. The answer A_{DIA} is transmitted through the user interface 160 back to the user U1, so as to achieve interactions between the language processing system 100 and the user U1.

To achieve a higher accuracy of the intent classifier ICM, it requires a large amount of the initial phrases Pini and corresponding initial intent labels Tini for training the intent classifier ICM. In some embodiments, the initial phrase Pini and the initial intent label Tini can be manually inputted by technical personnel or users. It is a huge task to collect and establish a large amount of the initial phrases Pini and corresponding initial intent labels.

As shown in FIG. 1, the processing unit 140 includes a phrase rewriter 142, which is able to produce augmented phrases Paug corresponding to the initial phrases Pini by sentence augmentation. In some embodiments, the language processing system 100 execute the sentence augmentation on the initial phrases Pini by the phrase rewriter 142 to generate augmented phrases Paug, and the language processing system 100 further provides a semi-supervised filtering on the augmented phrases Paug to select suitable ones among the augmented phrases Paug for training the intent classifier ICM by the training agent 144. In some embodiments, the data augmentation and the semi-supervised filtering can be executed in an end-to-end manner without further manual inputs.

In some embodiments, the phrase rewriter 142, the training agent 144 and the dialogue engine 146 can be implemented by computer-executable programs and/or software instructions executed by the processing unit 140. In some embodiments, the processing unit 140 can be a processor, a graphic processor, an application specific integrated circuit (ASIC) or any equivalent processing circuit.

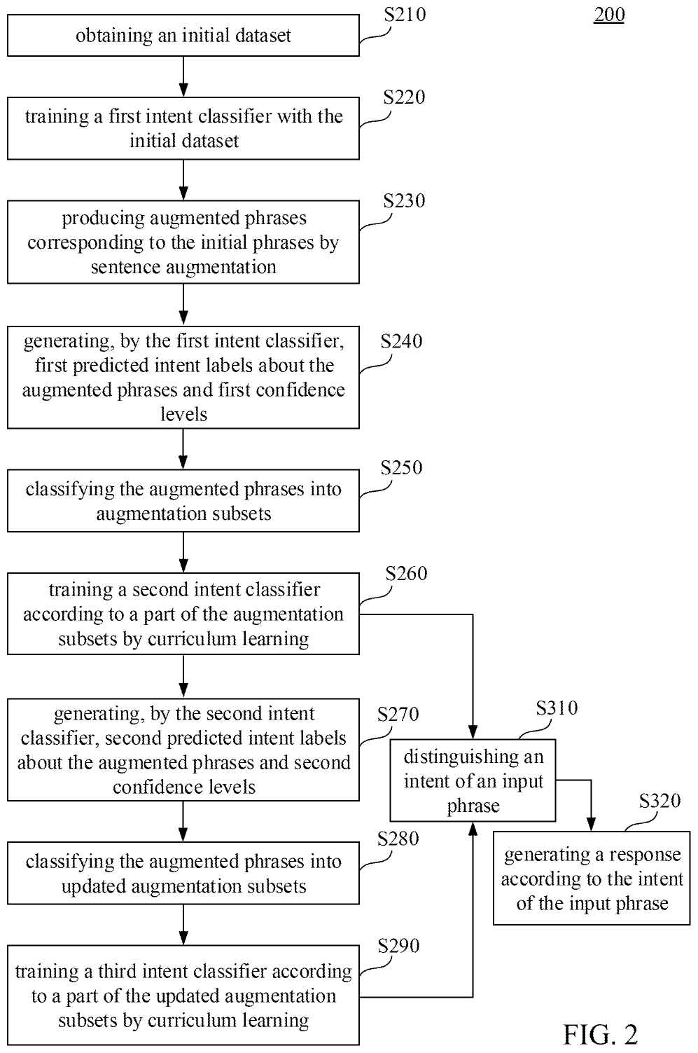

Reference is made to FIG. 2, which is a flow chart diagram illustrating a language processing method 200 according to some embodiments of the disclosure. The language processing method 200 can be executed by the language processing system 100 shown in FIG. 1.

The storage unit 120 is configured to further store computer-executable instructions. The processing unit 140 is coupled with the user interface 160 and the storage unit 120. The processing unit 140 is configured to execute the computer-executable instructions to implement the language processing method 200 discussed in following embodiments. The storage unit 120 can be a memory, a hard-drive, a cache memory, a flash memory and/or any equivalent data storage.

As shown in FIG. 1 and FIG. 2, step S210 is executed to obtain (or receive) an initial dataset Dini from a data source (not shown in figures). The initial dataset Dini can be stored in the storage unit 120 as shown in FIG. 1. In some embodiments, the data source can be a question-and-answer (Q&A) data server.

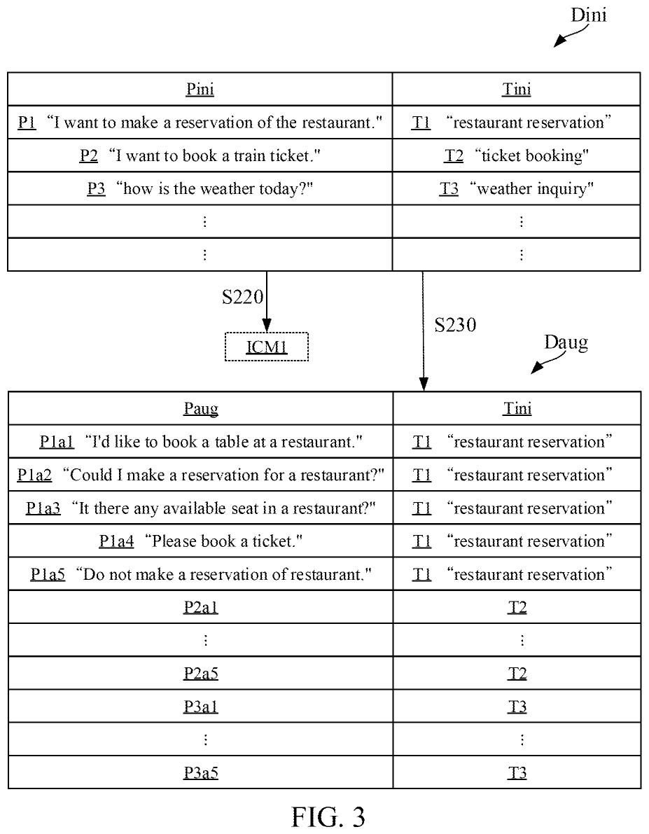

Reference is further made to FIG. 3, which is a schematic diagram illustrating the initial dataset Dini and an augmented dataset Daug according to a demonstrational example of this disclosure. As shown in the initial dataset Dini of FIG. 3, the initial phrases Pini includes a first initial phrase P1 “I want to make a reservation of the restaurant”, and the initial intent labels Tini includes a first intent label T1 “restaurant reservation” corresponding to the first initial phrase P1; the initial phrases Pini includes a second initial phrase P2 “I want to book a train ticket”, and the initial intent labels Tini includes a second intent label T2 “ticket booking” corresponding to the second initial phrase P2; the initial phrases Pini includes a third initial phrase P3 “how is the weather today?”, and the initial intent labels Tini includes a third intent label T3 “weather inquiry” corresponding to the third initial phrase P3.

As shown in FIG. 1, FIG. 2 and FIG. 3, step S220 is executed to train a first intent classifier ICM1 with the initial dataset Dini by the training agent 144.

In some embodiments, the first intent classifier ICM1 can be trained based on a cross-entropy loss function as below:

$$L ( θ ) = - \frac{1}{N} {\sum }_{i = 1}^{n} {y}_{i} log ( \hat{{y}_{ι}} ) , where \hat{{y}_{ι}} = {C}_{ICM 1} ( {x}_{i} ) \qquad equation ( 1 )$$

In equation (1), xᵢ are the initial phrases (e.g., P1, P2, P3); yᵢ are the initial intent labels (e.g., T1, T2, T3); ŷ_{ι} are predicted intent labels generated by the first intent classifier ICM1; N is the amount of the initial phrases.

It is noticed that the first intent classifier ICM1 is trained based on the initial dataset Dini, which include a limited amount of the initial phrases Pini and the initial intent labels Tini within the initial dataset Dini. In some embodiments, the initial dataset Dini does not include enough different example phrases corresponding to each of the initial intent labels. If the input phrase is about a similar question in a different wording, the first intent classifier ICM1 (trained according to the initial dataset Dini) may not able to recognize a correct intent. In other words, the initial dataset Dini and the first intent classifier ICM1 are not generalized enough.

In order to generalize the initial dataset Dini, step S230 is executed, by the phrase rewriter 142, to producing the augmented phrases corresponding to the initial phrases Pini by sentence augmentation. As shown in FIG. 3, the first initial phrase P1 “I want to make a reservation of the restaurant” of the initial phrases Pini can be rewritten by the phrase rewriter 142 into multiple augmented phrases P1a1, P1a2, P1a3, P1a4 and P1a5 corresponding to the first initial phrase P1.

In an embodiment, during step S230, the augmented phrases can be produced by rewriting the initial phrases by the large language model (LLM) to produce the augmented phrases. For example, the step S230 can be executed by enter a prompt command “please rewrite the following sentence of ‘I want to make a reservation of the restaurant’ in different ways” to the large language model (e.g., ChatGPT, Gemini, LLAMA, Mistral AI, Bard or Copilot), and collect responses from the large language model to produce the augmented phrases P1a1˜P1a5.

In another embodiment, during step S230, the augmented phrases P1a1˜P1a5 can be produced by translating the first initial phrase P1 in a first language (e.g., English) by a translation model (e.g., Google Translation, DeepL Translations) into intermediate phrases in a second language (e.g., France) and translating the intermediate phrases in the second language (e.g., France) by the translation model back to the first language (e.g., English), so as to produce the augmented phrases in the first language.

In another embodiment, during step S230, the augmented phrases P1a1˜P1a5 can be produced by replacing wordings in the first initial phrase P1 with synonyms related to the wordings. For example, the wording “restaurant” in the first initial phrase P1 can be replaced by a synonym like diner, bistro or cafeteria.

In still another embodiment, during step S230, the augmented phrases P1a1˜P1a5 can be produced by inserting random noises to the first initial phrase P1. The random noises can be randomly deleting one word in the first initial phrase P1, randomly exchanging sequence of words in the first initial phrase P1, or randomly adding an extra word in the first initial phrase P1. The random noises can simulate a typing error from a user.

As shown in FIG. 3, the augmented dataset Daug includes the augmented phrases P1a1˜P1a5 produced by sentence augmentation in step S230 from the first initial phrase P1. In the augmented dataset Daug, these augmented phrases P1a1˜P1a5 correspond to the first intent label T1 (matching with the first initial phrase P1) of the initial intent label Tini.

As shown in FIG. 2 and FIG. 3, during step S230, other augmented phrases P2a1˜P2a5 can be produced correspond to the second initial phrase P2 and augmented phrases P3a1˜P3a5 can be produced correspond to the third initial phrase P3. In the augmented dataset Daug, these augmented phrases P2a1˜P2a5 correspond to the second initial intent label T2 (matching with the second initial phrase P2) of the initial intent labels Tini. In the augmented dataset Daug, these augmented phrases P3a1˜P3a5 correspond to the third initial intent label T3 (matching with the third initial phrase P3) of the initial intent label Tini.

For brevity, the augmented phrases P1a1˜P1a5 are discussed in following paragraphs are demonstrational purposes. However, the disclosure is not limited thereto. Similar operations are applied on other initial phrases P2 and P3 to produce other augmented phrases P2a1˜P2a5 and P3a1˜P3a5.

It is noticed that the augmented phrases P1a1˜P1a5 in some embodiments are automatically produced based on sentence augmentation from the first initial phrase P1, without human supervision. In this case, it cannot ensure that the augmented phrases P1a1˜P1a5 remains their original intention label T1 “restaurant reservation”. In general, most of the augmented phrases P1a1˜P1a5 will have the intention same as the original intention label T1. However, some of the augmented phrases P1a1˜P1a5 after sentence augmentation may change their meanings or intentions. The first intent label T1 may be no longer suitable to represent the intentions of some of the augmented phrases P1a1˜P1a5.

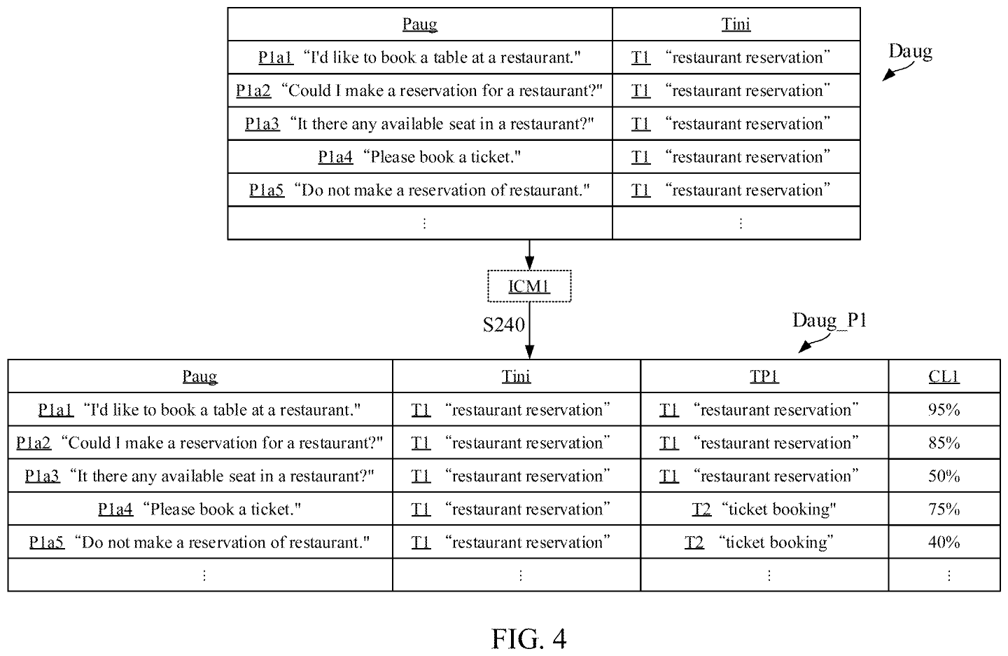

Reference is further made to FIG. 4, which is a schematic diagram illustrating the augmented dataset Daug and a first prediction dataset Daug_P1 related to step S240 according to a demonstrational example of this disclosure.

As shown in FIG. 1, FIG. 2 and FIG. 4, step S240 is executed, by the first intent classifier ICM1 operated in the processing unit 140, to generate first predicted intent labels TP1 about the augmented phrases Paug, and generate first confidence levels CL1 of the first predicted intent labels TP1.

As the first prediction dataset Daug_P1 shown in FIG. 4, the first predicted intent labels TP1 generated by the first intent classifier ICM1 related to the augmented phrases P1a1˜P1a5 are intent labels T1, T1, T1, T2 and T2.

Among the first predicted intent labels TP1 generated by the first intent classifier ICM1, the first intent classifier ICM1 may predict the augmented phrases P1a1, P1a2 and P1a3 to have the first intent label T1 same as the original intent label (i.e., the first intent label T1); and, the first intent classifier ICM1 may predict the augmented phrases P1a4 and P1a5 to have the second intent label T2 different from the original intent label (i.e., the first intent label T1). In addition, the first intent classifier ICM1 may generate the first confidence levels CL1 about the first predicted intent labels TP1, as shown in FIG. 4.

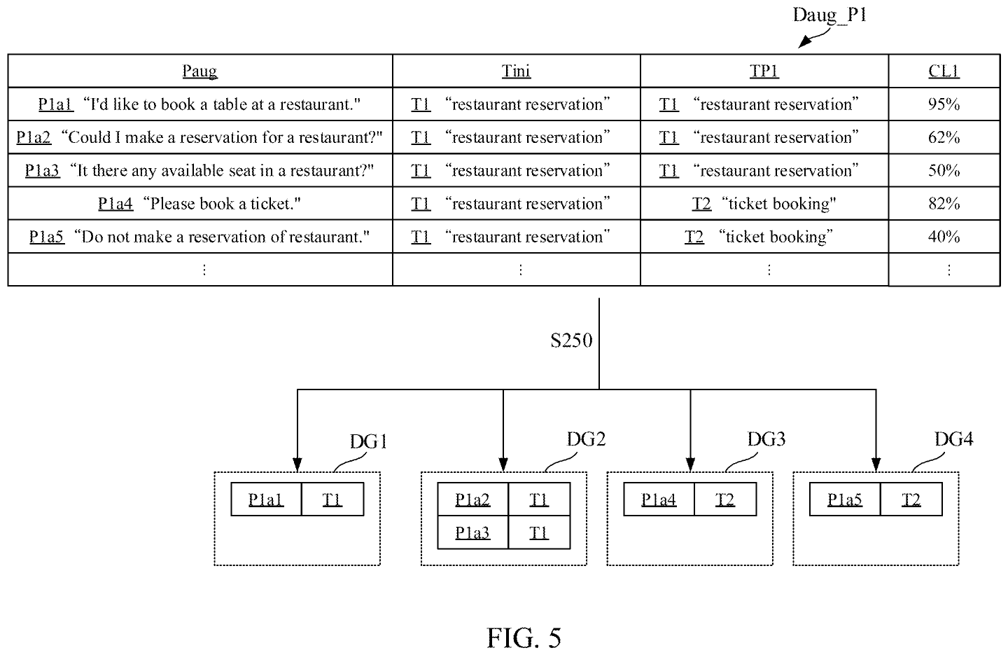

Reference is further made to FIG. 5, which is a schematic diagram illustrating the first prediction dataset Daug_P1 and augmentation subsets DG1˜DG4 after classification related to step S250 according to a demonstrational example of this disclosure.

As shown in FIG. 1, FIG. 2 and FIG. 5, step S250 is executed, by the processing unit 140, to classify the augmented phrases P1a1˜P1a5 in the first prediction dataset Daug_P1 into augmentation subsets DG1˜DG4 according to comparisons between the first predicted intent labels TP1 and the initial intent labels Tini and also according to the first confidence levels CL1.

In some embodiments, as shown in FIG. 2 and FIG. 5, the augmented phrase P1a1 with the first predicted intent labels TP1 (i.e., TP1 of the augmented phrase P1a1=T1) matching with the initial intent labels Tini (i.e., Tini of the augmented phrase P1a1=T1) and with the first confidence level (i.e., CL1 of the augmented phrase P1a1=95%) over a first confidence threshold (e.g., 80%) is classified into a first augmentation subset DG1. The augmented phrase P1a1 in the first augmentation subset DG1 has the predicted intention label same as the initial intention label and the first intent classifier ICM1 has a high confidence about the first augmentation subset DG1. In this case, the first augmentation subset DG1 is highly suitable to be added into a training data with a highest priority for training the intent classifier ICM.

In some embodiments, as shown in FIG. 2 and FIG. 5, the augmented phrases P1a2 and P1a3 with the first predicted intent labels TP1 (i.e., TP1 of the augmented phrases P1a2, P1a3=T1) matching with the initial intent labels Tini (i.e., Tini of the augmented phrases P1a2, P1a3=T1) and with the first confidence level (i.e., CL1 of the augmented phrase P1a2 and P1a3=62% and 50%) below the first confidence threshold (e.g., 80%) are classified into a second augmentation subset DG2. The augmented phrase P1a2 and P1a3 in the second augmentation subset DG2 has the predicted intention label same as the initial intention label and the first intent classifier ICM1 has a relatively lower confidence about the second augmentation subset DG2. The second augmentation subset DG2 may have a second priority in training the intent classifier ICM.

In some embodiments, as shown in FIG. 2 and FIG. 5, the augmented phrase P1a4 with the first predicted intent labels TP1 (i.e., TP1 of the augmented phrase P1a4=T2) different from the initial intent labels Tini (i.e., Tini of the augmented phrase P1a4=T1) and with the first confidence level (i.e., CL1 of the augmented phrase P1a4=82%) over the second confidence threshold (e.g., 80%) is classified into a third augmentation subset DG3. The augmented phrase P1a4 in the third augmentation subset DG3 has the predicted intention label different from the initial intention label and the first intent classifier ICM1 has a high confidence about the third augmentation subset DG3. The third augmentation subset DG3 may have a third priority in training the intent classifier ICM. The intention of the augmented phrase P1a4 has been changed during the sentence segmentation.

In some embodiments, as shown in FIG. 2 and FIG. 5, the augmented phrase P1a5 with the first predicted intent labels TP1 (i.e., TP1 of the augmented phrase P1a5=T2) different from the initial intent labels Tini (i.e., Tini of the augmented phrase P1a5=T1) and with the first confidence level (i.e., CL1 of the augmented phrase P1a5=40%) below the second confidence threshold (e.g., 80%) is classified into a fourth augmentation subset DG4. The augmented phrase P1a5 in the fourth augmentation subset DG4 has the predicted intention label different from the initial intention label and the first intent classifier ICM1 has a low confidence about the fourth augmentation subset DG4. The augmented phrase P1a5 in the fourth augmentation subset DG4 may be a bigger problem in distinguishing its intention. For example, the augmented phrase P1a5 after sentence augmentation can be ambiguous or meaningless. In this case, the fourth augmentation subset DG4 is not suitable for training the intent classifier ICM.

It is noticed that the first confidence threshold (e.g., 80%) and the second confidence threshold (e.g., 80%) discussed in aforesaid embodiment are for demonstrational purpose. The first confidence threshold and the second confidence threshold are not limited to this specific value. In some other embodiments, more confidence thresholds can be introduced to classify the augmented phrases into more augmentation subsets with different confidence levels, e.g., 100%˜81%, 80%˜61%, 60˜41%, 40%˜21% and 20%˜0% with the same intention label, and 100%˜81%, 80%˜61%, 60˜41%, 40%˜21% and 20%˜0% with a different intention label.

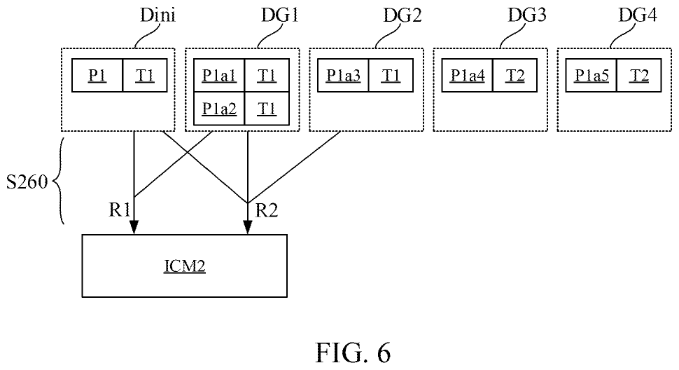

Reference is further made to FIG. 6, which is a schematic diagram illustrating a step S260 for training a second intent classifier ICM2 based on some of the augmentation subsets DG1˜DG4 after classification according to a demonstrational example of this disclosure.

As shown in FIG. 1, FIG. 2 and FIG. 6, step S260 is executed, by the training agent 144, to training a second intent classifier ICM2 according to a part of the augmentation subsets DG1˜DG4 by curriculum learning.

In some embodiments, the third augmentation subset DG3 and the fourth augmentation subset DG4 are classified according to the prediction generated by the first intent classifier ICM1 in an early stage. The predictions generated by the first intent classifier ICM1 are not solid and trustworthy enough. As shown in FIG. 6, the third augmentation subset DG3 and the fourth augmentation subset DG4 are not utilized to train a second intent classifier ICM2 during step S260.

As shown in FIG. 6, during a first round R1 of curriculum learning in step S260, the training agent 144 trains the second intent classifier ICM2 according to the initial dataset Dini and the first augmentation subset DG1. In other words, easier and most trustworthy training data are utilized in the first round R1 of curriculum learning for training the second intent classifier ICM2.

As shown in FIG. 6, during a second round R2 of curriculum learning in step S260, the training agent 144 trains the second intent classifier ICM2 according to the initial dataset Dini, the first augmentation subset DG1 and the second augmentation subset DG2. In other words, training data are utilized in the second round R2 of curriculum learning are extended to cover more training data with more variations. In this case, the second intent classifier ICM2 trained in this case can achieve a better generalization (covering more augmented phrases) and remain a higher accuracy by curriculum learning.

In some embodiments, the second intent classifier ICM2 can be trained based on a cross-entropy loss function as below:

$$L ( θ ) = - λ [ \frac{1}{N} {\sum }_{i = 1}^{N} {y}_{i} log ( \hat{{y}_{ι}} ) ] - {λ}_{SS} [ \frac{1}{M} {\sum }_{i = 1}^{M} {y}_{i}^{′} log ( \hat{{y}_{ι}} ) ] where \hat{{y}_{ι}} = {C}_{ICM 2} ( {x}_{i}^{j} ) \qquad equation ( 2 )$$

In equation (2), xᵢ are the initial phrases (e.g., P1, P2, P3); yᵢ are the initial intent labels (e.g., T1, T2, T3); yᵢ′ are intent labels of the augmented phrases P1a1˜P1a3 (same as the initial intent label T1) in the first augmentation subset DG1 and the second augmentation subset DG2; ŷ_{ι} are predicted intent labels generated by the second intent classifier ICM2; λ is a weight factor for the initial dataset Dini; λ_{SS} is another weight factor for the first augmentation subset DG1 and the second augmentation subset DG2; N is the amount of the initial phrases; M is the amount of the augmented phrases in the first augmentation subset DG1 and the second augmentation subset DG2.

It is noticed that the first intent classifier ICM1 is trained based on the initial dataset Dini, which include a limited amount of the initial phrases Pini and the initial intent labels Tini within the initial dataset Dini. In some embodiments, the initial dataset Dini does not include enough different example phrases corresponding to each of the initial intent labels. If the input phrase is about a similar question in a different wording, the first intent classifier ICM1 (trained according to the initial dataset Dini) may not able to recognize a correct intent. In other words, the initial dataset Dini and the first intent classifier ICM1 are not generalized enough. On the other hand, the second intent classifier ICM2 is trained based on the initial dataset Dini, augmentation subset DG1 and the second augmentation subset DG2. The second intent classifier ICM2 is able to achieve a better generalization than the first intent classifier ICM1.

As shown in FIG. 1 and FIG. 2, the second intent classifier ICM2 can be utilized in step S310 to distinguish an intent T_{DIA} of the input phrase P_{DIA} from the user U1. In step S320, the dialogue engine 146 is able to generate a response A_{DIA} according to the intent T_{DIA} (distinguished based on the second intent classifier ICM2) of the input phrase P_{DIA}. In some embodiments, the disclosure is not limited to stop at the second intent classifier ICM2. More cycles of the curriculum learning can be repeated to update the intent classifier ICM, so as to further increase the accuracy of the intent classifier ICM.

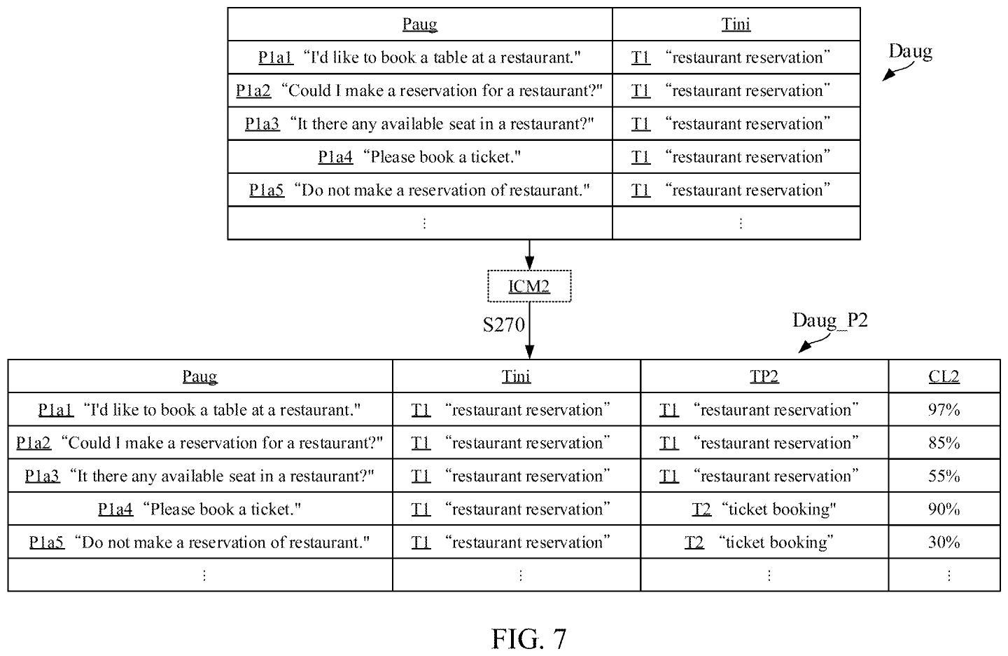

Reference is further made to FIG. 7, which is a schematic diagram illustrating the augmented dataset Daug and a second prediction dataset Daug_P2 related to step S270 according to a demonstrational example of this disclosure.

As shown in FIG. 1, FIG. 2 and FIG. 7, step S270 is executed, by the second intent classifier ICM2 operated in the processing unit 140, to generate second predicted intent labels TP2 about the augmented phrases Paug, and generate second confidence levels CL2 of the second predicted intent labels TP2. In this case, because the second intent classifier ICM2 has been trained based on the initial dataset Dini and a part of the augmented datasets DG1 and DG2. The second predicted intent labels TP2 and the second confidence levels CL2 (in the second prediction dataset Daug_P2 shown in FIG. 7) generated by the second intent classifier ICM2 may be different and more accurate compared to the first predicted intent labels TP1 and the first confidence levels CL2 (in the first prediction dataset Daug_P1 shown in FIG. 4) generated by the first intent classifier ICM1.

As the second prediction dataset Daug_P2 shown in FIG. 7, the second predicted intent labels TP2 generated by the second intent classifier ICM2 related to the augmented phrases P1a1˜P1a5 are intent labels T1, T1, T1, T2 and T2. In addition, the second intent classifier ICM2 may generate the second confidence levels CL2 about the second predicted intent labels TP2, as shown in FIG. 7. The behavior of step S270 is similar to step S240. The main difference between steps S270 and S240 is that the step S270 is executed based on the second intent classifier ICM2 (trained according to the initial dataset Dini and also the augmentation subsets DG1˜DG2 in the first prediction dataset Daug_P1), not based on the first intent classifier ICM1 (trained according to the initial dataset Dini).

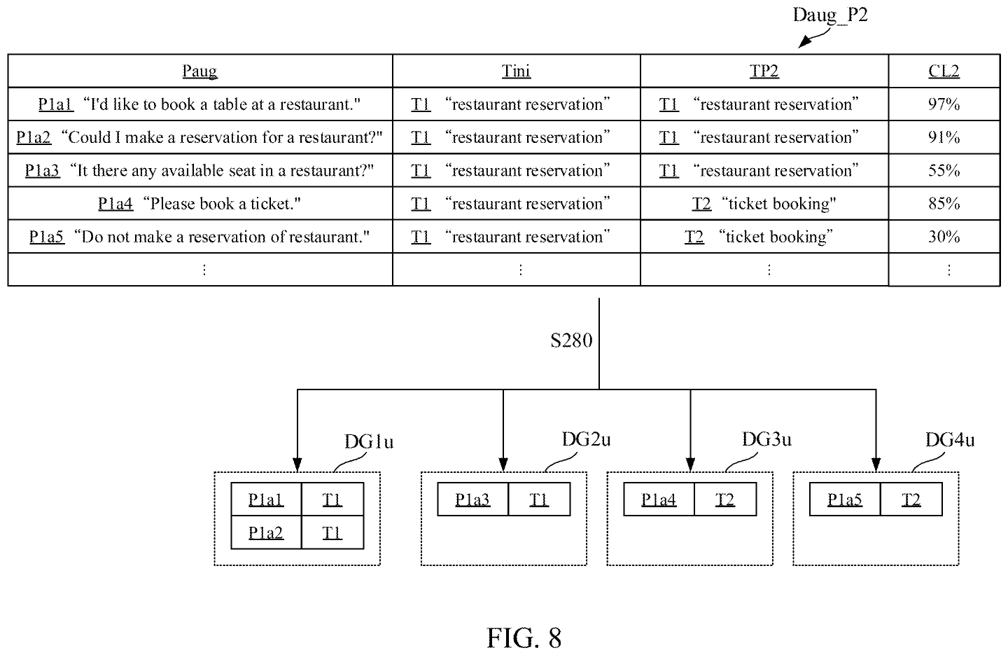

Reference is further made to FIG. 8, which is a schematic diagram illustrating the second prediction dataset Daug_P2 and updated augmentation subsets DG1u˜DG4u after classification related to step S280 according to a demonstrational example of this disclosure.

As shown in FIG. 1, FIG. 2 and FIG. 8, step S280 is executed, by the processing unit 140, to classify the augmented phrases P1a1˜P1a5 in the second prediction dataset Daug_P2 into updated augmentation subsets DG1u˜DG4u according to comparisons between the second predicted intent labels TP2 and the initial intent labels Tini and also according to the second confidence levels CL2.

In some embodiments, as shown in FIG. 2 and FIG. 8, the augmented phrases P1a1 and P1a2 are classified into a first updated augmentation subset DG1u; the augmented phrases P1a3 are classified into a second updated augmentation subset DG2u; the augmented phrases P1a4 are classified into a third updated augmentation subset DG3u; and, the augmented phrases P1a5 are classified into a fourth updated augmentation subset DG4u. The behavior of step S280 is similar to step S250.

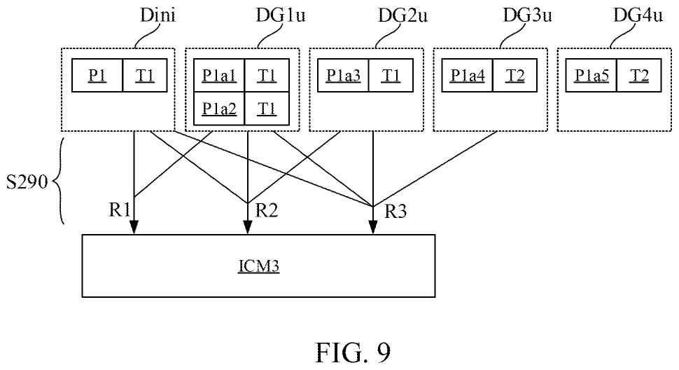

Reference is further made to FIG. 9, which is a schematic diagram illustrating a step S290 for training a third intent classifier ICM3 based on some of the updated augmentation subsets DG1u˜DG4u after classification according to a demonstrational example of this disclosure.

As shown in FIG. 1, FIG. 2 and FIG. 9, step S290 is executed, by the training agent 144, to training the third intent classifier ICM3 according to a part of the updated augmentation subsets DG1u˜DG4u by curriculum learning.

In some embodiments, as shown in FIG. 9, the fourth updated augmentation subset DG3 is not utilized to train a third intent classifier ICM3 during step S290.

As shown in FIG. 9, during a first round R1 of curriculum learning in step S290, the training agent 144 trains the third intent classifier ICM3 according to the initial dataset Dini and the first updated augmentation subset DG1u. In other words, easier and most trustworthy training data are utilized in the first round R1 of curriculum learning for training the third intent classifier ICM3.

As shown in FIG. 9, during a second round R2 of curriculum learning in step S290, the training agent 144 trains the third intent classifier ICM3 according to the initial dataset Dini, the first updated augmentation subset DG1u and the second updated augmentation subset DG2u. In other words, training data are utilized in the second round R2 of curriculum learning are extended to cover more training data with more variations.

As shown in FIG. 9, during a third round R3 of curriculum learning in step S290, the training agent 144 trains the third intent classifier ICM3 according to the initial dataset Dini, the first updated augmentation subset DG1u, the second updated augmentation subset DG2u and the third updated augmentation subset DG3u. It is noticed that the second predicted intent labels TP2 generated by the second intent classifier ICM2 about the augmented phrases P1a4 in the third updated augmentation subset DG3u are utilized as the ground truth in training the third intent classifier ICM3. In other words, the augmented phrases P1a4 is no longer regarded as a phrase about the intent label T1, and is now regarded as a phrase about the intent label T2 (based on the prediction of the second intent classifier ICM2).

In some embodiments, the third intent classifier ICM3 can be trained based on a cross-entropy loss function as below:

$$L ( θ ) = - λ [ \frac{1}{N} {\sum }_{i = I}^{N} {y}_{i} log ( \hat{{y}_{ι}} ) ] - {λ}_{SS} [ \frac{1}{M} {\sum }_{i = 1}^{M} {y}_{i}^{′} log ( \hat{{y}_{ι}} ) ] - {λ}_{S D} [ \frac{1}{Q} {\sum }_{i = I}^{Q} {y}_{i}^{″} log ( \hat{{y}_{ι}} ) ] where \hat{{y}_{ι}} = {C}_{ICM 3} ( {x}_{i}^{j} ) \qquad equation ( 3 )$$

In equation (3), xᵢ are the initial phrases (e.g., P1, P2, P3); yᵢ are the initial intent labels (e.g., T1, T2, T3); yᵢ′ are intent labels of the augmented phrases P1a1˜P1a3 (same as the initial intent label T1) in the first augmentation subset DG1 and the second augmentation subset DG2; yᵢ″ are intent labels of the augmented phrase P1a4 (e.g., T2) in the third augmentation subset DG3; ŷ_{ι} are predicted intent labels generated by the third intent classifier ICM3; λ is a weight factor for the initial dataset Dini; λ_{SS} is another weight factor for the first augmentation subset DG1 and the second augmentation subset DG2; λ_{SD} is another weight factor for the third augmentation subset DG3; N is the amount of the initial phrases; M is the amount of the augmented phrases in the first augmentation subset DG1 and the second augmentation subset DG2; Q is the amount of the augmented phrases in the third augmentation subset DG3.

As shown in FIG. 1 and FIG. 2, the third intent classifier ICM3 can be utilized in step S310 to distinguish an intent T_{DIA} of the input phrase P_{DIA} from the user U1. In step S320, the dialogue engine 146 is able to generate a response A_{DIA} according to the intent T_{DIA} (distinguished based on the third intent classifier ICM3) of the input phrase P_{DIA}. In some embodiments, the disclosure is not limited to stop at the third intent classifier ICM3. More cycles of the curriculum learning can be repeated to update the intent classifier ICM, so as to further increase the accuracy of the intent classifier ICM.

It is noticed that, while training the third intent classifier ICM3, the third updated augmentation subset DG3u is also utilized as the training data in the third round R3 of curriculum learning. It is because the third updated augmentation subset DG3u is generated based on the second intent classifier ICM2 in a later stage, compared to the third augmentation subset DG3 generated based on the first intent classifier ICM1 in an earlier stage. In this case, the third updated augmentation subset DG3u is relatively trustworthy. Therefore, the third updated augmentation subset DG3u can be added into the training data, so as to further extend the variations of augmentation data.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A language processing method, comprising:
obtaining an initial dataset comprising initial phrases and initial intent labels about the initial phrases;
training a first intent classifier with the initial dataset;
producing augmented phrases corresponding to the initial phrases by sentence augmentation;
generating, by the first intent classifier, first predicted intent labels about the augmented phrases and first confidence levels of the first predicted intent labels;
classifying the augmented phrases into augmentation subsets according to comparisons between the first predicted intent labels and the initial intent labels and according to the first confidence levels; and
training a second intent classifier according to a part of the augmentation subsets by curriculum learning, wherein the second intent classifier is configured to distinguish an intent of an input phrase within a dialogue.

2. The language processing method of claim 1, wherein step of classifying the augmented phrases into the augmentation subsets comprises:
classifying the augmented phrases having the first predicted intent labels matching with the initial intent labels and having the first confidence levels over a first confidence threshold into a first augmentation subset;
classifying the augmented phrases having the first predicted intent labels matching with the initial intent labels and having the first confidence levels below the first confidence threshold into a second augmentation subset;
classifying the augmented phrases having the first predicted intent labels mismatching with the initial intent labels and having the first confidence levels over a second confidence threshold into a third augmentation subset; and
classifying the augmented phrases having the first predicted intent labels mismatching with the initial intent labels and having the first confidence levels below the second confidence threshold into a fourth augmentation subset.

3. The language processing method of claim 2, wherein step of training the second intent classifier by curriculum learning comprising:
training the second intent classifier according to the initial dataset and the first augmentation subset during a first round of curriculum learning; and
training the second intent classifier according to the initial dataset, the first augmentation subset and the second augmentation subset during a second round of curriculum learning.

4. The language processing method of claim 3, wherein the third augmentation subset and the fourth augmentation subset are not utilized to train the second intent classifier.

5. The language processing method of claim 1, further comprising:
generating, by the second intent classifier, second predicted intent labels about the augmented phrases and second confidence levels of the second predicted intent labels;
classifying the augmented phrases into updated augmentation subsets with reference to the second predicted intent labels and the second confidence levels; and
training a third intent classifier according to the updated augmentation subsets by curriculum learning.

6. The language processing method of claim 5, wherein step of classifying the augmented phrases into the updated augmentation subsets comprises:
classifying the augmented phrases having the second predicted intent labels matching with the initial intent labels and having the second confidence levels over a first confidence threshold into a first updated augmentation subset;
classifying the augmented phrases having the second predicted intent labels matching with the initial intent labels and having the second confidence levels below the first confidence threshold into a second updated augmentation subset;
classifying the augmented phrases having the first predicted intent labels mismatching with the initial intent labels and having the second confidence levels over a second confidence threshold into a third updated augmentation subset; and
classifying the augmented phrases having the first predicted intent labels mismatching with the initial intent labels and having the second confidence levels below the second confidence threshold into a fourth updated augmentation subset.

7. The language processing method of claim 6, wherein step of training the third intent classifier by curriculum learning comprising:
training the third intent classifier according to the initial dataset and the first updated augmentation subset during a first round of curriculum learning; and
training the third intent classifier according to the initial dataset, the first updated augmentation subset and the second updated augmentation subset during a second round of curriculum learning; and
training the third intent classifier according to the initial dataset, the first updated augmentation subset, the second updated augmentation subset and the third updated augmentation subset during a third round of curriculum learning.

8. The language processing method of claim 7, wherein the fourth updated augmentation subset is not utilized to train the third intent classifier.

9. The language processing method of claim 7, wherein the second predicted intent labels generated by the second intent classifier about the augmented phrases are utilized as ground truths in training the third intent classifier.

10. The language processing method of claim 1, wherein step of producing the augmented phrases by sentence augmentation based on the initial phrases comprises:
rewriting the initial phrases by a large language model (LLM) to produce the augmented phrases.

11. The language processing method of claim 1, wherein step of producing the augmented phrases by sentence augmentation based on the initial phrases comprises:
translating the initial phrases in a first language by a translation model into intermediate phrases in a second language different from the first language; and
translating the intermediate phrases in the second language by the translation model into the augmented phrases in the first language.

12. The language processing method of claim 1, wherein step of producing the augmented phrases by sentence augmentation based on the initial phrases comprises:
replacing wordings in the initial phrases with synonyms related to the wordings for producing the augmented phrases.

13. The language processing method of claim 1, wherein step of producing the augmented phrases by sentence augmentation based on the initial phrases comprises:
inserting random noises to the initial phrases for producing the augmented phrases.

14. The language processing method of claim 1, further comprising:
generating a response according to the intent of the input phrase.

15. A language processing system, comprising:
a storage unit, configured to store computer-executable instructions; and
a processing unit, coupled with the storage unit, the processing unit is configured to execute the computer-executable instructions to:
obtain an initial dataset comprising initial phrases and initial intent labels about the initial phrases;
train a first intent classifier with the initial dataset;
produce augmented phrases by sentence augmentation based on the initial phrases;
execute the first intent classifier to generate first predicted intent labels about the augmented phrases and first confidence levels of the first predicted intent labels;
classify the augmented phrases into augmentation subsets according to comparisons between the first predicted intent labels and the initial intent labels and according to the first confidence levels; and
train a second intent classifier according to a part of the augmentation subsets by curriculum learning, wherein the second intent classifier is configured to distinguish an intent of an input phrase within a dialogue.

16. The language processing system of claim 15, wherein the processing unit classifies the augmented phrases into the augmentation subsets by:
classifying the augmented phrases having the first predicted intent labels matching with the initial intent labels and having the first confidence levels over a first confidence threshold into a first augmentation subset;
classifying the augmented phrases having the first predicted intent labels matching with the initial intent labels and having the first confidence levels below the first confidence threshold into a second augmentation subset;
classifying the augmented phrases having the first predicted intent labels mismatching with the initial intent labels and having the first confidence levels over a second confidence threshold into a third augmentation subset; and
classifying the augmented phrases having the first predicted intent labels mismatching with the initial intent labels and having the first confidence levels below the second confidence threshold into a fourth augmentation subset.

17. The language processing system of claim 16, wherein the processing unit trains the second intent classifier by curriculum learning by:
training the second intent classifier according to the initial dataset and the first augmentation subset during a first round of curriculum learning; and
training the second intent classifier according to the initial dataset, the first augmentation subset and the second augmentation subset during a second round of curriculum learning,
wherein the third augmentation subset and the fourth augmentation subset are not utilized to train the second intent classifier.

18. The language processing system of claim 15, wherein the processing unit is further configured to:
execute the second intent classifier to generate second predicted intent labels about the augmented phrases and second confidence levels of the second predicted intent labels;
classify the augmented phrases into updated augmentation subsets with reference to the second predicted intent labels and the second confidence levels; and
train a third intent classifier according to the updated augmentation subsets by curriculum learning.

19. The language processing system of claim 18, wherein the processing unit classifies the augmented phrases into the updated augmentation subsets by:
classifying the augmented phrases having the second predicted intent labels matching with the initial intent labels and having the second confidence levels over a first confidence threshold into a first updated augmentation subset;
classifying the augmented phrases having the second predicted intent labels matching with the initial intent labels and having the second confidence levels below the first confidence threshold into a second updated augmentation subset;
classifying the augmented phrases having the first predicted intent labels mismatching with the initial intent labels and having the first confidence levels over a second confidence threshold into a third updated augmentation subset; and
classifying the augmented phrases having the first predicted intent labels mismatching with the initial intent labels and having the first confidence levels below the second confidence threshold into a fourth updated augmentation subset.

20. The language processing system of claim 19, wherein the processing unit trains the third intent classifier by curriculum learning by:
training the third intent classifier according to the initial dataset and the first updated augmentation subset during a first round of curriculum learning; and
training the third intent classifier according to the initial dataset, the first updated augmentation subset and the second updated augmentation subset during a second round of curriculum learning; and
training the third intent classifier according to the initial dataset, the first updated augmentation subset, the second updated augmentation subset and the third updated augmentation subset during a third round of curriculum learning,
wherein the fourth updated augmentation subset is not utilized to train the third intent classifier.
